(19) United States
(12) Patent Application Publication
(10) Pub. No.: US 2006/0161276 A1
(43) Pub. Date: Jul. 20, 2006

(54) Automated online commercial computer game tournament service

(76) Inventor: Ramin A. Soltani, Katonah, NY (US)

Correspondence Address: Ramin Soltani, 2 Elmer Galloway Rd., Katonah, NY, 10536, US

(21) Appl. No.: 11/035,444

(22) Filed: Jan. 14, 2005

(51) Int. Cl. G06F 155/00

(52) U.S. Cl. 700/91

(57) ABSTRACT

The automated online tournament service is an internet service which will allow its subscribers to compete against one another for money they place on their registered service accounts in commercial and original computer game titles. Countless tournaments will be running 24 hours a day 7 days a week to accommodate the demand of the respective subscribers so that any time during the day or night, a subscriber may log on and use the money allocated to their service account as stakes in their favorite commercial computer game titles. The service will charge either a small percentage of the winnings in every game or a monthly or yearly subscriber's fee in return for providing this service to online commercial computer game players.

The automated online tournament service is a service for online computer game players. The problem that online garners face is that there are no tangible stakes to whether they win or lose when competing against other online computer garners from all over the world. The automated online tournament service will run automated tournaments 24 hours a day, 7 days a week. By doing this, the service will allow its subscribers to allocate money to their service accounts and use that money as stakes when playing licensed commercial computer games such as Doom, Half-Life, Warcraft, Command and Conquer etc. against other computer garners from all over the world.

The automated online tournament service would be installed on the respective online computer gamer's computer via internet download or computer disc. The online computer gamer would then be required to set up a registered account with the service. Once the online computer gamer has the software installed and the account registered they would then have the option of allocating money through a credit card or other form of secure payment to their service account. Where the automated online tournament service differs from any other service is here, where the online computer gamer will now be able to use their money as stakes in one or many of their favorite commercial computer game titles. They will have the option of choosing which type of automated tournament they would like to join. Some tournaments will be hosting first person shooters such as Doom or Half-Life, some tournaments will be hosting strategy games such as Warcraft or Command and Conquer, some tournaments will be hosting role playing games such as Diablo or Daggerfall, and other tournaments will be hosting games of other genres such as adventure and action games. Furthermore, the online computer gamer will have the option of how much of the money they have allocated to their service account they would like to compete for. Some tournaments will be hosting $0.25 games, some will be hosting $0.50 games, some will be hosting $1.00 games, some will be hosting $5.00 games, and the numbers go up from there. The online computer gamer will also have the option of the size of tournament he would like to join in respect to the number of players, he/she could join a 2 person game or a 10 person game, or more. In order to provide the online computer gamer with as many options as possible, countless tournaments of all types must be running simultaneously in order to accommodate the online computer gamer. Once the player decides the title, stakes and size of the tournament they are comfortable playing in, they will click on the respective icon within the program interface and be prompted to the game. Once the game is over, depending on whether the computer gamer won or lost, the funds in their service account will either be augmented or reduced.

It is important to note that games of chance or games with properties that involve the element of chance are not eligible for play in the automated online tournament service. Only computer games such as first person shooters, strategy games, role playing games etc. will be in play, games which are purely based on intellect, skill, experience and hand/eye coordination.

There are tournaments online which provide cash prizes to winners, however, there has never been an internet service which provides tournaments automatically and consistently, twenty four hours a day, seven days a week in respect to commercial computer game titles, and for tangible stakes, until now with this automated online tournament service.

Since the online computer gamers are competing for eachother's money, the fee the service will charge for providing the service could be either a tiny percentage of an online computer gamer's winnings within each game, or a monthly or yearly subscriber's fee. Furthermore, in addition to licensing commercial computer game titles, the automated online tournament service could also provide its own original titles for its subscriber's enjoyment and use within the service.

The particulars of the service are that it could be run a number of different ways. The tournaments could allow for players to win or lose points while playing the computer game and exit the game with their winnings or losses at any point within the game or the tournament could require players to stay for the duration of the game until one player attains a certain score or until a pre-set time limit lapses. Also, the interface of the automated online tournament service could allow for chat between players before games are launched in chat boxes within the interface, much like many online services already have. The main idea is to create a community where online computer gamers will be able to play their favorite commercial computer game titles for tangible stakes via this automated online tournament service.

1. I claim the right to an automated online commercial computer game tournament service.
An online service which provides online computer garners with the means to compete against one another in licensed commercial and original computer game titles against one another for tangible stakes.
